(19) United States
(12) Patent Application Publication
(10) Pub. No.: US 2026/0269755 A1
(43) Pub. Date: Sep. 10, 2026

(54) Method and Device for Determining an Estimated Value of a Measurement Offset of a Phase Current Sensor

(71) Applicant: Bayerische Motoren Werke Aktiengesellschaft, Muenchen (DE)

(72) Inventors: Nick BURMESTER, Duesseldorf (DE); Jovan KNEZEVIC, Muenchen (DE)

(21) Appl. No.: 19/166,920

(22) PCT Filed: Feb. 20, 2024
(86) PCT No.: PCT/EP2024/054236

§ 371 Date: Sep. 19, 2025

(30) Foreign Application Priority Data
Mar. 20, 2023 (DE) 10 2023 106 907.1

(51) Int. Cl. H02P 21/18; H02P 21/00

(52) U.S. Cl. CPC H02P 21/18; H02P 21/0017

(57) ABSTRACT

The present disclosure describes a device for determining an estimated value of a measurement offset of a phase current sensor for a phase current of an electric machine. The device is configured to determine a measurement value of a control error of a current controller for setting the phase current of the electric machine for a time; use a model that is dependent on the stator inductance of the electric machine to determine a model value of the control error for the time based on the estimated value of the measurement offset of the phase current sensor for the time; and use a filter unit to determine the estimated value of the measurement offset of the phase current sensor for a subsequent time based on the measurement value of the control error and based on the model value of the control error.

### BACKGROUND AND SUMMARY

The invention relates to a method and a corresponding device which are configured to determine the offset of a phase current sensor of an electric machine.

An electrically driven vehicle has an electric drive machine which can be operated with multiple, generally N, for example N=3, phase currents. The phase currents can be generated by a converter on the basis of a direct current supplied by an electrical energy store. The individual phase currents can be detected and monitored in each case by a current sensor which is arranged on the respective phase line. The measurement values of N-1 current sensors can here be used for the regulation of the phase currents. The Nth current sensor can be used for a total-current plausibility check.

Over the lifetime of a phase current sensor and/or because of temperature fluctuations, it can happen that the measurement values of the phase current sensor have a measurement offset and/or that the measurement offset of the phase current sensor changes. This can result in inaccuracies in the operation of the electric drive machine of the vehicle.

The present document is concerned with the technical object of enabling an efficient, precise, and robust determination of the measurement offset of a phase current sensor, in particular in order to effect permanently reliable operation of an electric machine.

The object is addressed by each of the independent claims. Advantageous embodiments are described, inter alia, in the dependent claims. It should be pointed out that additional features of a claim dependent on an independent claim can form, without the features of the independent claim or only in combination with a subset of the features of the independent claim, a separate invention which is independent of the combination of all the features of the independent claim and can be made the subject of an independent claim, a divisional application, or a subsequent application. This equally applies to the technical teachings described in the description and which can form an invention which is independent of the features of the independent claim.

According to one aspect, a device is described for determining an estimated value of the measurement offset of a phase current sensor for a phase current of a (possibly three-phase) electric machine (for example, a synchronous machine). The device can be configured to determine the estimated value of the measurement offset of the phase current sensor in each case for the d axis and for the q axis of the dq coordinate system of the electric machine. The estimated value of the measurement offset of the phase current sensor can then be transformed by means of an inverse Park transformation from the dq coordinate system into the three-phase system of the electric machine in order to determine an estimated value of the measurement offset of a first phase current sensor for a first phase and an estimated value of the measurement offset of a second phase current sensor for a second phase of the electric machine.

The determination of the estimated value can thus be made in the dq coordinate system of the electric machine. The determination can moreover take place iteratively at a sequence of successive points in time.

The device is configured to determine repeatedly, at in each case one point in time of the sequence of successive points in time, a measurement value of the regulation error of the current regulator for adjusting the phase current of the electric machine for the point in time (in each case for the d axis and for the q axis). The regulation error of the current regulator is typically dependent on the measurement offset of one or more phase current sensors.

The device is moreover configured to determine repeatedly, at in each case one point in time of the sequence of successive points in time, a model value of the regulation error for the point in time by means of a model dependent on at least one stator inductivity of the electric machine on the basis of the estimated value of the measurement offset of the phase current sensor for the point in time (in each case for the d axis and for the q axis). The (mathematical) model can be dependent on the L_{q} stator inductivity and on the L_{d} stator inductivity, where the L_{q} stator inductivity and the L_{d} stator inductivity are different.

A mathematical model can thus be used in order to determine, on the basis of the previously determined estimated value of the measurement offset, a model value of the regulation error which should correspond to the measurement value of the regulation error. The estimated value of the measurement offset can be adapted iteratively in order to reduce (in particular, to minimize) the deviation of the model value of the regulation error from the measurement value of the regulation error and in this way to determine the estimated value of the measurement offset efficiently and precisely.

The device can in particular be configured to determine the estimated value of the measurement offset of the phase current sensor for the point in time (directly) following the respective point in time by means of a filter unit on the basis of the measurement value of the regulation error and on the basis of the model value of the regulation error. The device, in particular the filter unit, can be configured to determine the estimated value of the measurement offset of the phase current sensor by means of a phase-locked loop (PLL). The PLL can here depend on the electrical frequency of the electric machine and/or on the (electrical) rotational speed of the electric machine. The estimated value of the measurement offset can be determined particularly robustly and precisely by the use of a (PLL-based) filter unit.

The filter unit can comprise a band-pass filter (or take the form of a band-pass filter). The device can be configured to determine the electrical frequency and/or the (electrical) rotational speed of the electric machine for the respective point in time. The band-pass filter, in particular the pass-band width of the band-pass filter, can then be adapted depending on the electrical frequency and/or the (electrical) rotational speed of the electric machine. Alternatively or additionally, the model can be adapted depending on the (electrical) rotational speed of the electric machine. The estimated value of the measurement offset can thus be determined particularly precisely and robustly.

The device can be configured to filter by means of the filter unit, in particular by means of the band-pass filter of the filter unit, a signal which is dependent on the measurement value of the regulation error for the point in time and on the model value of the regulation error for the point in time, in particular one dependent on the difference between the measurement value and the model value. The estimated value of the measurement offset of the phase current sensor for the following point in time can then be determined particularly precisely and robustly on the basis of the filtered signal.

The device can be configured to determine the input value of the filter unit on the basis of the measurement value of the regulation error for the point in time and on the basis of the model value of the regulation error for the point in time, in particular on the basis of the difference between the measurement value of the regulation error for the point in time and the model value of the regulation error for the point in time. The estimated value of the measurement offset of the phase current sensor for the following point in time can then be determined by means of the filter unit on the basis of the input value of the filter unit. The filter unit can here be configured to adapt the estimated value of the measurement offset of the phase current sensor in the sequence of points in time in such a way that the input value (possibly the cumulative input value over the sequence of points in time) is reduced. The estimated value of the measurement offset can thus be determined particularly precisely and robustly.

As already explained above, the measurement value of the regulation error, the model value of the regulation error, and the estimated value of the measurement offset of the phase current sensor can be determined in each case for the d axis and for the q axis of the dq coordinate system of the electric machine in order to enable particularly precise current regulation of the electric machine.

The (mathematical) model can be dependent on and/or comprise, in particular can correspond to

$${i}_{d \_ m} - \frac{{ω}_{cc}}{s + {ω}_{cc}} \{ {i}_{d}^{*} \} = \frac{s}{s + {ω}_{cc}} \{ Δ {i}_{d \_ off} \} - \frac{{ω}_{e} {L}_{q} s}{{L}_{d} {s}^{2} + ( {ω}_{cc} {L}_{d} + {R}_{s} ) s + {ω}_{cc} {R}_{s}} \{ Δ {i}_{q \_ off} \}$$

$${i}_{q \_ m} - \frac{{ω}_{cc}}{s + {ω}_{cc}} \{ {i}_{q}^{*} \} = \frac{s}{s + {ω}_{cc}} \{ Δ {i}_{q \_ off} \} + \frac{{ω}_{e} {L}_{d} s}{{L}_{q} {s}^{2} + ( {ω}_{cc} {L}_{q} + {R}_{s} ) s + {ω}_{cc} {R}_{s}} \{ Δ {i}_{d \_ off} \}$$

where.
i_{d_m}, i_{q_m} is a model value of the measurement value of the (at least one) phase current sensor for the d axis or for the q axis of the dq coordinate system of the electric machine;

$${i}_{d}^{*} , {i}_{q}^{*}$$

is the target value of the phase current (for the current regulator) for the d axis or for the q axis of the dq coordinate system;

$${i}_{d \_ m} - \frac{{ω}_{c c}}{s + {ω}_{c c}} \{ {i}_{d}^{*} \} , {i}_{q \_ m} - \frac{{ω}_{cc}}{s + {ω}_{cc}} \{ {i}_{q}^{*} \}$$

is the model value of the regulation error for the d axis or for the q axis of the dq coordinate system;
Δi_{d_off}, Δi_{q_off} is the estimated value of the measurement offset of the phase current sensor for the d axis or for the q axis of the dq coordinate system;
ω_{cc} is the bandwidth of the current regulator;
Rₛ is the electrical resistance of the stator of the electric machine;
L_{d}, L_{q} is the stator inductivity for the d axis and for the q axis of the dq coordinate system; and/or.
ωₑ is the electrical rotational speed of the electric machine.

The abovementioned mathematical model enables particularly precise determination of the estimated value of the measurement offset.

The device can be configured to detect a measurement value for the phase current for the following point in time by means of the (at least one) phase current sensor (and to transform it into the dq coordinate system). The measurement value for the phase current can be corrected (in the dq coordinate system) by means of the estimated value of the measurement offset of the phase current sensor for the following point in time in order to determine a corrected measurement value for the phase current for the following point in time. Moreover, the phase current can be adjusted, in particular as part of the current regulation, depending on the corrected measurement value for the phase current, in particular can be regulated to the target value for the phase current. Particularly precise operation of the electric machine can thus be effected.

According to a further aspect, a (road) motor vehicle (in particular a car or a truck or a bus or a motorcycle) is described which comprises the device described in this document. The vehicle moreover comprises an electric drive machine.

According to a further aspect, a method for determining an estimated value of the measurement offset of at least one phase current sensor for a phase current of an electric machine is described. One or more estimated values in the dq coordinate system can here be determined and transformed into the three-phase system of the electric machine.

The method comprises determining repeatedly, at in each case one point in time of a sequence of successive points in time, a measurement value of the regulation error of the current regulator for adjusting the phase current of the electric machine for the respective point in time. The method furthermore comprises determining, by means of a model dependent on at least one stator inductivity of the electric machine, a model value of the regulation error for the point in time on the basis of the estimated value of the measurement offset of the phase current sensor for the respective point in time.

The method moreover comprises determining, by means of a (PLL) filter unit, the estimated value of the measurement offset of the phase current sensor for the point in time following (directly in the sequence of points of time) the respective point in time on the basis of the measurement value of the regulation error for the point in time and on the basis of the model value of the regulation error for the point in time.

According to a further aspect, a software (SW) program is described. The SW program can be configured so as to be executed on a processor (for example, on a control unit of a vehicle) and to consequently execute the method described in this document.

According to a further aspect, a storage medium is described. The storage medium can comprise an SW program which is configured so as to be executed on a processor and to consequently execute the method described in this document.

It should be noted that the methods, devices, and systems described in this document can be used both on their own and in combination with other methods, devices, and systems described in this document. Furthermore, any aspects of the methods, devices, and systems described in this document can be combined with one another in various fashions. In particular, the features of the claims can be combined with one another in various fashions. Moreover, features presented in parentheses are to be understood as optional features.

Forms of the invention will be described in detail below on the basis of exemplary embodiments.

### BRIEF DESCRIPTION OF DRAWINGS

FIG. 1a shows an exemplary inverter or converter for an electric machine of a vehicle;

FIG. 1b shows an exemplary progression of a phase voltage;

FIG. 2 shows exemplary current regulation circuits in the dq coordinate system for current regulation of an electric machine;

FIG. 3 shows an exemplary device for determining an estimated value of the offset of a current sensor; and

FIG. 4 shows a flow diagram of an exemplary method for determining an estimated value of an offset of a phase current sensor.

### DETAILED DESCRIPTION OF DRAWINGS

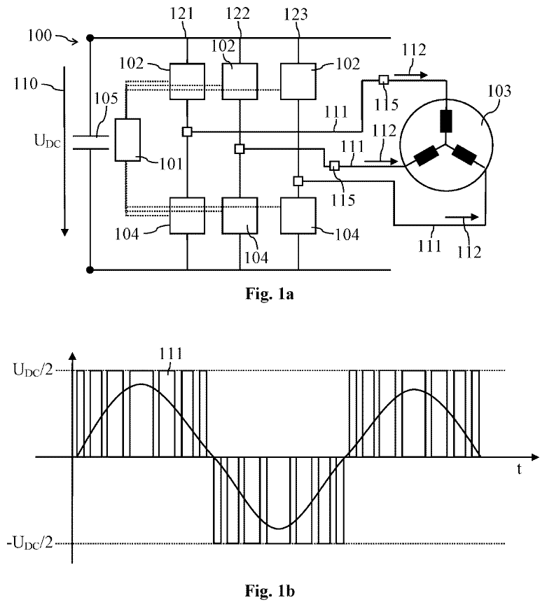

As discussed above, the present document is concerned with the efficient and precise determination of the measurement offset of a phase current sensor of a multi-phase electric machine. In this connection, FIG. 1a shows an exemplary inverter 100 which is configured to generate phase voltages 111 (i.e. alternating voltages) for the stator coils of an electric machine 103 (for example, of a vehicle) on the basis of a vehicle electric system voltage UDC 110 (i.e. a direct voltage). The inverter 100 can have an intermediate circuit with an intermediate circuit capacitor 105 at which the vehicle electric system voltage UDC 110 is applied.

The inverter 100 (or converter) comprises multiple switches or switching elements 102, 104 which in the example illustrated are arranged for each phase 121, 122, 123 in each case in a half-bridge. The switching elements 102, 104 are activated by a control device 101 in order to generate the phase voltages 111 for the electric machine 103.

FIG. 1b shows an exemplary phase voltage 111 which can be generated by the switching elements 102, 104 of a half-bridge. As can be seen in FIG. 1b, the switching elements 102, 104 are switched (i.e. opened or closed) with a specific pulse pattern in order to generate a (sinusoidal) alternating voltage 111. The pulse pattern for a specific (static) operating point of the electric machine 103 can be determined in advance, for example by means of an optimization method such as, for example, SOPWM (synchronous optimal pulse width modulation) by means of which a specific optimization criterion (for example, the harmonic distortion of the phase currents) can be optimized, in particular minimized. The determined pulse patterns for different operating points of the electric machine 103 can be stored, for example in a look-up table (LUT). The individual pulse patterns here have, for each wave or half-wave of the alternating voltage to be generated, in each case a specific number M of pulses, where M is a whole number (for example, M=1, 2, 3, 4, 5, 6 or higher).

The different operating points of the electric machine 103 can comprise, for example, different torques to be provided and/or different rotational speeds.

The device 101 can be configured to effect current regulation, in particular regulation of the phase currents 112 for the different phases 121, 122, 123 of the electric machine 103, in order to adjust a specific operating point of the electric machine 103. For this purpose, measurement values for the phase currents 112 in the different phases 121, 122 can be detected by means of current sensors 115. It is here typically sufficient for N different phases 121, 122, 123 (for example, N=3) to detect measurement values for N−1 phases because the phase current 112 on the Nth phase 123 is the result of the total current from the other N−1 phases 121, 122 (for example, is zero). The inverter 100 therefore advantageously has only N-current sensors 115 for N−1 corresponding phase currents 112.

The measurement values of the phase currents of the individual phases a (121), b (122), and c (123) can be defined for N=3 as follows:

$${i}_{as \_ m} = {i}_{as} + Δ {i}_{as \_ off} \qquad ( 1 )$$

$${i}_{bs \_ m} = {i}_{bs} + Δ {i}_{bs \_ off} \qquad ( 2 )$$

$${i}_{cs \_ m} = - {i}_{as \_ m} - {i}_{bs \_ m} = {i}_{cs} - ( Δ {i}_{as \_ off} + Δ {i}_{bs \_ off} ) \qquad ( 3 )$$

where iₐₛ, i_{bs}, and i_{cs} are the correct values of the phase currents for the first phase a, for the second phase b, and respectively for the third phase c. Δi_{as_off} is the measurement offset of the first current sensor 115 for the first phase and Δi_{bs_off} is the measurement offset of the second current sensor 115 for the second phase. i_{as_m} and i_{bs_m} are the actual measurement values of the current sensors 115 for the first phase and for the second phase, and i_{cs_m} is the actual measurement value of the current sensor 115 for the third phase (if present).

The abovementioned currents can be transformed into the dq coordinate system by means of a Park transformation such that

$$Δ {i}_{d \_ off} = Δ {i}_{as \_ off} \cdot cos {θ}_{e} + \frac{1}{\sqrt{3}} ( Δ {i}_{as \_ off} + 2 Δ {i}_{bs \_ off} ) \cdot sin {θ}_{e} \qquad ( 4 )$$

$$Δ {i}_{q \_ off} = - Δ {i}_{as \_ off} \cdot sin {θ}_{e} + \frac{1}{\sqrt{3}} ( Δ {i}_{as \_ off} + 2 Δ {i}_{bs \_ off} ) \cdot cos {θ}_{e} \qquad ( 5 )$$

$$or correspondingly in a matrix format$$

$${\underbrace{[ \begin{matrix}Δ {i}_{d \_ off} \\ Δ {i}_{q \_ off}\end{matrix} ]}}_{Δ {i}_{dq \_ off}} = {\underbrace{[ \begin{matrix}cos {θ}_{e} & sin {θ}_{e} \\ - sin {θ}_{e} & cos {θ}_{e}\end{matrix} ]}}_{T} {\underbrace{[ \begin{matrix}Δ {i}_{as \_ off} \\ \frac{1}{\sqrt{3}} ( Δ {i}_{as \_ off} + 2 Δ {i}_{bs \_ off} )\end{matrix} ]}}_{Δ {i}_{off}} \qquad ( 6 )$$

Here, Oe is the electric rotation angle of the electric machine 103. Δi_{d_off} is the d component of the measurement offset, and Δi_{q_off} is the q component of the measurement offset in the dq coordinate system. In particular, Δi_{d_off} describes the influence of the measurement offset of the phase current sensors 115 on the d component of the current, and Δi_{q_off} describes the influence of the measurement offset of the phase current sensors 115 on the q component of the current.

The abovementioned equation can be reformulated as follows:

$$Δ {i}_{d \_ off} = {k}_{off} sin ( {θ}_{e} + α ) \qquad ( 7 )$$

$$Δ {i}_{q \_ off} = {k}_{off} cos ( {θ}_{e} + α ) \qquad ( 8 )$$

$$where$$

$${k}_{off} = \sqrt{Δ {I}_{as \_ off}^{2} + \frac{1}{3} {( Δ {i}_{as \_ off} + 2 Δ {i}_{bs \_ off} )}^{2}} \qquad ( 9 )$$

$$α = {tan}^{- 1} \{ \frac{\sqrt{3} Δ {i}_{as \_ off}}{Δ {i}_{as \_ off} + 2 Δ {i}_{bs \_ off}} \} \qquad ( 10 )$$

It can be seen from the equations (7) and (8) that the measurement offsets of the phase current sensors 115 cause a harmonic wave in the phase currents 112 in the dq coordinate system, wherein the harmonic wave has a frequency which corresponds to the electrical rotational speed We of the rotor.

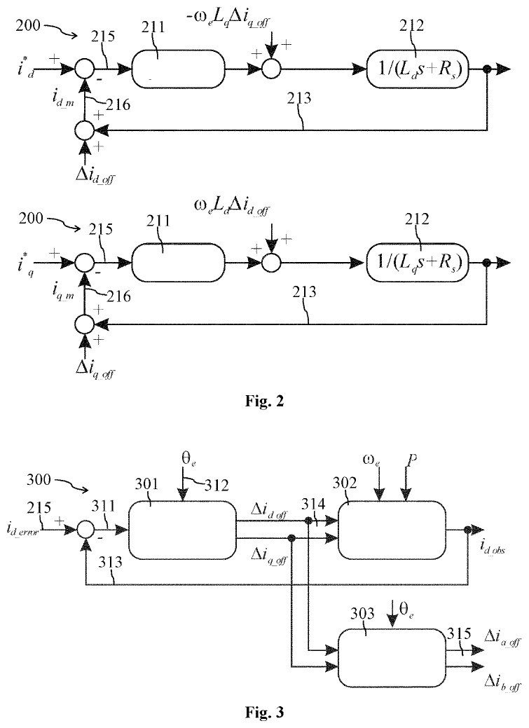

FIG. 2 shows exemplary current regulation circuits 200 for the d component (top) and for the q component (bottom) of the current. The regulation circuits 200 have in each case a regulator 211 and a system 212 to be regulated. The system 212 to be regulated can here be modeled by the formula illustrated in each case. The actual values 213 of the d component and the q component of the current which are distorted by the respective measurement offset is supplied by the system 212 to be regulated such that the measured values 216 of the current result. The regulation circuits 200 illustrated in FIG. 2 can also be applied for a current-excited synchronous machine.

Assuming that the regulators 211 (in particular the PI regulators) have a bandwidth of @cc, the following formulae can be determined for the d component and for the q component of the current:

$${i}_{d \_ m} = \frac{{ω}_{cc}}{s + {ω}_{cc}} \{ {i}_{d}^{*} \} + \frac{s}{s + {ω}_{cc}} \{ Δ {i}_{d \_ off} \} - \frac{{ω}_{e} {L}_{q} s}{{L}_{d} {s}^{2} + ( {ω}_{cc} {L}_{d} + {R}_{s} ) s + {ω}_{cc} {R}_{s}} \{ Δ {i}_{q \_ off} \} \qquad ( 11 )$$

$${i}_{q \_ m} = \frac{{ω}_{cc}}{s + {ω}_{cc}} \{ {i}_{q}^{*} \} + \frac{s}{s + {ω}_{cc}} \{ Δ {i}_{q \_ off} \} + \frac{{ω}_{e} {L}_{d} s}{{L}_{q} {s}^{2} + ( {ω}_{cc} {L}_{q} + {R}_{s} ) s + {ω}_{cc} {R}_{s}} \{ Δ {i}_{d \_ off} \} or \qquad ( 12 )$$

$${i}_{d \_ m} - \frac{{ω}_{cc}}{s + {ω}_{cc}} \{ {i}_{d}^{*} \} = \frac{s}{s + {ω}_{cc}} \{ Δ {i}_{d \_ off} \} - \frac{{ω}_{e} {L}_{q} s}{{L}_{d} {s}^{2} + ( {ω}_{cc} {L}_{d} + {R}_{s} ) s + {ω}_{cc} {R}_{s}} \{ Δ {i}_{q \_ off} \} \qquad ( 13 )$$

$${i}_{q \_ m} - \frac{{ω}_{cc}}{s + {ω}_{cc}} \{ {i}_{q}^{*} \} = \frac{s}{s + {ω}_{cc}} \{ Δ {i}_{q \_ off} \} + \frac{{ω}_{e} {L}_{d} s}{{L}_{q} {s}^{2} + ( {ω}_{cc} {L}_{q} + {R}_{s} ) s + {ω}_{cc} {R}_{s}} \{ Δ {i}_{d \_ off} \} \qquad ( 14 )$$

FIG. 3 shows an exemplary device 300 which is designed to determine estimated values 314 for the measurement offset Δi_{d_off}, Δi_{q_off} (in the dq coordinate system) on the basis of the abovementioned formulae, in particular on the basis of the formulae (11) and (12). The device 300 comprises a modeling unit 302 which is configured to determine, on the basis of the abovementioned formulae, in particular on the basis of the formulae (11) and (12) and on the basis of the estimated values 314 for the measurement offset, model values 313 i_{d_obs} for the measurement values of i_{d_m}, i_{q_m} and/or (on the basis of the formulae (13) and (14)) for the regulation error. It is thus possible on the basis of the formulae to supply an observer in order to estimate the phase currents measured by the sensors 115 and/or the regulation error 215 of the current regulation circuits 200.

The model values 313 of the regulation error can be subtracted from the corresponding measurement values 215 of the regulation error of the current regulator 200 in order to determine input values 311 for a filter unit 301, in particular for a phase-locked loop (PLL) filter unit 301. The input values 311 should ideally be zero.

The filter unit 301 can take the form of a band-pass filter by means of which a signal with the electrical frequency fₑ(θₑ=2π*fₑ*t) can be extracted from the input values 311, in particular from the difference between the input values 311 and the output values 314 (i.e. the estimated values of the measurement offset), of the filter unit 301. As explained above, the measurement offsets are dependent on this electrical frequency.

The filter unit 301 is moreover configured to reduce the input values 311 iteratively, in particular to minimize them (to zero). If this is the case, the model values 313 i_{d_obs}, determined by the modeling unit 302, of the regulation error match the measurement values 215 of the regulation error and thus precise estimated values 314 of the measurement offset are supplied.

The filter unit 301 can be designed according to the explanations in the paper by M Karimi-Ghartemani and A. K. Ziaran, “Performance characterization of a non-linear system as both an adaptive notch filter and a phase-locked loop”, INTERNATIONAL JOURNAL OF ADAPTIVE CONTROL AND SIGNAL PROCESSING, Int. J. Adapt. Control Signal Process. 2004; 18:23-53 (see in particular FIGS. 2 and 5). The content of this paper is included in its entirety by reference in the present document.

The estimated values 314 of the measurement offsets can be transformed in a transformation unit 303 from the dq coordinate system into the abc coordinate system in order to supply estimated values 315 of the measurement offsets Δi_{as_off}, Δi_{bs_off}.

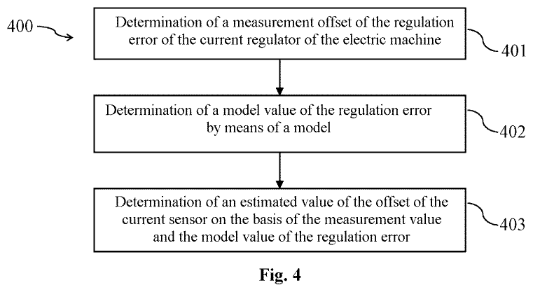

FIG. 4 shows a flow diagram of a (optionally computer-implemented) method 400 for determining an estimated value 314, 315 of a measurement offset of a phase current sensor 115 for a phase current 112 of an electric machine 103. The method 400 can be designed to determine the estimated value 314 of the measurement offset of at least one phase current sensor (in particular for exactly two phase current sensors) 115 in each case for the d axis and q axis of the dq coordinate system. Alternatively or additionally, the estimated value 315 of the measurement offset of a phase current sensor 115 can be determined in each case for different phases 121, 122 in the three-phase system of the electric machine 103.

The method 400 can be performed repeatedly at in each case one point in time of a sequence of successive points in time. In each case one current estimated value 314, 315 of the measurement offset can here be determined, in particular be updated, recursively.

The method 400 comprises (at in each case one point in time of the sequence of points in time) determination 401 of the measurement value 215 of the regulation error of the current regulator 200 in order to adjust the phase current 112 of the electric machine 103 for the point in time (in each case for the d axis and for the q axis). The measurement value 215 of the regulation error can here (in a steady-state condition of the current regulator 200) be dependent on the measurement offset of the phase current sensor 115.

The method 400 furthermore comprises the determination 402, by means of a model 302 dependent on the stator inductivity of the electric machine 103, of a model value 313 of the regulation error for the point in time on the basis of the estimated value 314, 315 of the measurement offset of the phase current sensor 115 for the point in time.

The method 400 moreover comprises the determination 403, by means of a filter unit 301 (with a band-pass filter), of the estimated value 314, 315 of the measurement offset of the phase current sensor 115 for a point in time following the point in time on the basis of the measurement value 215 of the regulation error for the point in time and on the basis of the model value 313 of the regulation error for the point in time.

The features described in this document make possible a particularly efficient and precise determination of the measurement offset of at least one phase current sensor 115 of an electric machine 103, as a result of which the reliability of the current regulation and thus of the operation of the electric machine 103 is increased.

The present invention is not restricted to the exemplary embodiments shown. It should in particular be noted that the description and the Figures are intended to illustrate the principle of the proposed methods, devices, and systems only by way of example.

1-12. (canceled)

13. A device for determining an estimated value of a measurement offset of a phase current sensor for a phase current of an electric machine, the device comprising:
a processor configured to determine repeatedly, at each point in time of a sequence of successive points in time:
a measurement value of a regulation error of a current regulator for adjusting the phase current of the electric machine for the point in time;
a model value of the regulation error for the point in time by means of a model dependent on at least one stator inductivity of the electric machine on the basis of the estimated value of the measurement offset of the phase current sensor for the point in time; and
the estimated value of the measurement offset of the phase current sensor for a point in time following the point in time by means of a filter unit on the basis of the measurement value of the regulation error and on the basis of the model value of the regulation error.

14. The device of claim 13, wherein:
the filter unit comprises a band-pass filter; and
the processor is further configured to:
determine an electrical frequency and/or an electrical rotational speed of the electric machine for the point in time; and
adapt a pass-band width of the band-pass filter depending on the electrical frequency and/or the electrical rotational speed of the electric machine.

15. The device of claim 13, wherein the processor is configured to:
filter with a band-pass filter of the filter unit a signal which is dependent on a measurement value of the regulation error for the point in time and on the model value of the regulation error for the point in time; and
determine the estimated value of the measurement offset of the phase current sensor for the following point in time on the basis of the filtered signal.

16. The device of claim 13, wherein the processor is further configured to:
determine an input value of the filter unit on the basis of the measurement value of the regulation error for the point in time and on the basis of the model value of the regulation error for the point in time on the basis of a difference between the measurement value of the regulation error for the point in time and the model value of the regulation error for the point in time; and
determine the estimated value of the measurement offset of the phase current sensor for the following point in time by means of the filter unit on the basis of the input value of the filter unit.

17. The device of claim 16, wherein the filter unit is configured to adapt the estimated value of the measurement offset of the phase current sensor in the sequence of points in time in such a way that the input value is reduced.

18. The device of claim 13, wherein the filter unit is configured to determine the estimated value of the measurement offset of the phase current sensor by means of a phase-locked loop with respect to an electrical frequency of the electric machine, wherein the electrical frequency depends on an electrical rotational speed of the electric machine.

19. The device of claim 13, wherein the processor is further configured to:
determine the measurement value of the regulation error, the model value of the regulation error, and the estimated value of the measurement offset of the phase current sensor in each case for a d axis and for a q axis of a dq coordinate system of the electric machine; and
transform the estimated value of the measurement offset of the phase current sensor by means of an inverse Park transformation from the dq coordinate system into a three-phase system in order to determine an estimated value of the measurement offset of a first phase current sensor for a first phase and an estimated value of the measurement offset of a second phase current sensor for a second phase of the electric machine.

20. The device of claim 13, wherein:
the model is dependent on a L_{q} stator inductivity and on a L_{d} stator inductivity; and
the L_{q} stator inductivity and the L_{d} stator inductivity are different.

21. The device of claim 13, wherein the processor is further configured to:
determine an electrical rotational speed of the electric machine for the point in time; and
adapt the model depending on the electrical rotational speed.

22. The device of claim 13, wherein the model is dependent on and/or comprises:
$${i}_{d \_ m} - \frac{{ω}_{cc}}{s + {ω}_{cc}} \{ {i}_{d}^{*} \} = \frac{s}{s + {ω}_{cc}} \{ Δ {i}_{d \_ off} \} - \frac{{ω}_{e} {L}_{q} s}{{L}_{d} {s}^{2} + ( {ω}_{cc} {L}_{d} + {R}_{s} ) s + {ω}_{cc} {R}_{s}} \{ Δ {i}_{q \_ off} \}$$
$${i}_{q \_ m} - \frac{{ω}_{cc}}{s + {ω}_{cc}} \{ {i}_{q}^{*} \} = \frac{s}{s + {ω}_{cc}} \{ Δ {i}_{q \_ off} \} + \frac{{ω}_{e} {L}_{d} s}{{L}_{q} {s}^{2} + ( {ω}_{cc} {L}_{q} + {R}_{s} ) s + {ω}_{cc} {R}_{s}} \{ Δ {i}_{d \_ off} \}$$
wherein:
i_{d_m}, i_{q_m}, is a model value of the measurement value of the phase current sensor for a d axis or for a q axis of a dq coordinate system of the electric machine;
$${i}_{d}^{*} , {i}_{q}^{*}$$
is a target value of the phase current for the d axis or for the q axis of the dq coordinate system;
$${i}_{d \_ m} - \frac{{ω}_{c c}}{s + {ω}_{c c}} \{ {i}_{d}^{*} \} , {i}_{q \_ m} - \frac{{ω}_{cc}}{s + {ω}_{cc}} \{ {i}_{q}^{*} \}$$
is the model value of the regulation error;
Δi_{d_off}, Δi_{q_off} is the estimated value of the measurement offset of the phase current sensor for the d axis and for the q axis of the dq coordinate system;
ω_{cc} is a bandwidth of the current regulator;
Rₛ is an electrical resistance of a stator of the electric machine;
L_{d}, L_{q} is a stator inductivity for the d axis and for the q axis of the dq coordinate system; and
ωₑ is an electrical rotational speed of the electric machine.

23. The device of claim 13, wherein the processor is configured to:
detect a measurement value for the phase current for the following point in time by means of the phase current sensor;
correct the measurement value for the phase current by means of the estimated value of the measurement offset of the phase current sensor for the following point in time in order to determine a corrected measurement value for the phase current for the following point in time; and
adjust the phase current as part of the current regulation depending on the corrected measurement value for the phase current to regulate the phase current to a target value for the phase current.

24. A method for determining an estimated value of a measurement offset of a phase current sensor for a phase current of an electric machine, wherein the method comprises, repeatedly, at in each case one point in time of a sequence of successive points in time:
determining a measurement value of a regulation error of a current regulator for adjusting the phase current of the electric machine for the point in time;
determining, by means of a model dependent on a stator inductivity of the electric machine, a model value of the regulation error for the point in time on the basis of the estimated value of the measurement offset of the phase current sensor for the point in time; and
determining, by means of a filter unit, the estimated value of the measurement offset of the phase current sensor for a point in time following the point in time on the basis of the measurement value of the regulation error for the point in time and on the basis of the model value of the regulation error for the point in time.
